(19) United States
(12) Patent Application Publication
(10) Pub. No.: US 2017/0343444 A1
(43) Pub. Date: Nov. 30, 2017

(54) PRESSURE MEASURING SENSOR

(71) Applicant: Valeo Systemes de Controle Moteur, Cergy Saint Christophe (FR)

(72) Inventors: Xavier Michaudet, Caen (FR); Jean Sannier, Juaye Mondaye (FR); David Lesaunier, Thaon (FR); Didier Le Cunff, Carriere Sous Poissy (FR)

(73) Assignee: Valeo Systemes de Controle Moteur, Cergy Saint Christophe (FR)

(21) Appl. No.: 15/538,477

(22) PCT Filed: Dec. 21, 2015
(86) PCT No.: PCT/FR2015/053678

§ 371 Date: Jun. 21, 2017

(30) Foreign Application Priority Data
Dec. 22, 2014 (FR) 1463156

(51) Int. Cl. G01L 19/14; F16H 59/68

(52) U.S. Cl. CPC G01L 19/143; F16H 59/68; F16H 2059/683

(57) ABSTRACT

The present invention proposes a sensor, comprising a first element, a second element having a circular portion, the first element being configured to hold the circular portion of the second element against the first element at a holding angle less than 360 degrees.

This invention relates to a pressure-measuring sensor and, more particularly, a pressure-measuring sensor used in motor vehicles.

Many sensors used in serial production consist of a metal body, a measuring element, a signal-conditioning electronic circuit, a connector and a housing to close the sensor.

Usually, the connection between the sensor and the vehicle is made by means of the sensor body. More precisely, the body is fixed to the housing by crimping. The body comprises a circular portion that is completely crimped. Crimping is thus performed round 360 degrees. This fixing technique requires the connector to exit the body along the axis of the sensor, meaning that at least one portion of the connector is straight.

The drawback of this solution is that it takes up a lot of space and reduces the possibility of mounting this sensor beneath the engine housing of motor vehicles, where the available space is ever more limited.

The aim of the invention is to improve this situation by proposing a sensor that can be easily integrated.

To this end, the invention proposes a sensor comprising a first element and a second element comprising a circular portion, the first element being configured to hold the circular portion of the second element against the first element, at a holding angle of less than 360 degrees. It is thus possible to place part of an element of the sensor in the zone not involved in holding, in the extension of the second element. In this way, the space occupied by the sensor in terms of height is limited.

According to an embodiment of the invention, the holding angle is less than 360 degrees and more than or equal to 180 degrees. Preferably, the holding angle is between 200 degrees and 280 degrees, and very preferably the holding angle is equal to 260 degrees.

This value is a compromise between efficiency of holding and freeing up space in order to limit the space occupied by the sensor in terms of height.

According to an embodiment of the invention, the holding angle is defined by the circular portion.

According to an embodiment of the invention, the sensor has a first element comprising a flat surface, a second element comprising a circular portion and resting on the flat surface of the first element, the first element being configured so as to hold the first and second element against one another at a part of the circular portion of the second element, this part of the circular portion defining an angle in the center that is strictly less than 360 degrees, this angle being viewed in a direction perpendicular to the flat surface of the first element.

According to an embodiment of the invention, the first element comprises a holding wall surrounding the circular portion of the second element, the first and second element being held against one another by deformation of the holding wall. This ensures that the sensor can be fitted without adding an additional part.

According to an embodiment of the invention, the first and second element are held against one another by a portion of the thrust washer arranged on the circular portion of the second element and on which the holding wall rests once it is deformed. This allows the stresses in the second element to be distributed more evenly than in the case of direct pressure of the first element on the second element.

According to an embodiment of the invention, several deformations of the holding wall are made in different directions. For example, V-shaped notches are made in the holding wall. Alternatively, an additional deformation is made in the holding wall by pressing a round-ended punch against the holding wall. This allows the contact forces between the first and the second element, and thus the strength of the assembly, to be locally increased.

Preferably, the first element is metallic. This type of material offers good mechanical strength.

According to an embodiment of the invention, the first element is made of stainless steel. This type of material can be used for its good anticorrosion properties.

According to an embodiment of the invention, the first element is made of steel coated with a surface treatment. This type of material is less expensive than stainless steel and withstands corrosion better than uncoated steel.

As a variation, the first element is made of brass. This type of material is economical and easy to machine.

As a variation, the first element is made of aluminum.

According to an embodiment of the invention, the first element is a part obtained by casting.

The use of a cast part to make the body of the sensor allows complex shapes to be obtained, which would be difficult to obtain by machining.

According to an embodiment of the invention, the holding wall is perpendicular to a flat surface of the second element held against the first element.

The holding wall thus allows the second element to be guided when it is positioned against the first element.

According to an embodiment, the second element comprises a connector.

The connector forms an integral part of the second element. It is possible, for example, to over-mold the second element onto connection tabs.

According to an embodiment of the invention, the connector of the second element is mounted at the end of a flexible cable. The use of a flexible cable facilitates the connection of the sensor, the flexible extension cable offering further possibilities for positioning the connector.

According to an embodiment of the invention, the first element comprises a thread enabling the sensor to be screwed onto a part of which a property is to be measured.

According to an embodiment of the invention, the first element comprises an orifice allowing a screw to pass through in order to fix it to a part of which a property is to be measured. A precise angular position of the sensor is thus obtained.

According to an embodiment of the invention, the sensor comprises a sensitive element allowing the pressure of a fluid to be measured. The fluid can, for example, be air or a gaseous mixture containing fuel.

For example, the sensor comprises a sensitive element allowing the pressure of a liquid to be measured. The liquid can in particular be a fuel, a cooling fluid or a hydraulic fluid.

According to an embodiment of the invention, the first element comprises a sensitive element allowing the oil pressure of an automatic gearbox for a motor vehicle to be measured. This allows the electronic system controlling the gearbox to optimize the gear change phases.

According to an embodiment of the invention, the sensor comprises an additional zone for holding the second element against the first element. By creating an additional holding zone, the maximum strength of the assembly is increased.

Preferably, the additional holding zone is outside the circular portion of the second element. Access to the second holding zone is thus facilitated and its efficiency is increased.

The additional holding zone is configured so as to prevent the rotation of the second element in relation to the first element. This limits the torsion torque capable of being applied between the first and the second element when only the first holding zone exists.

As a variation of in addition, the additional holding zone is configured so as to prevent the displacement of the second element in relation to the first element. As before, it is possible to limit the stress that is applied between the two elements when the stress is in a different direction to that tending to create a rotational movement of one element in relation to the other.

According to an embodiment, the distance separating the second zone holding the center from the circular portion of the second element is within 1.1 and 2.5 times the radius of the circular portion of the second element. By moving the second holding zone away from the first, its efficiency is improved since for a given applied torque, the maximum strain will decrease if one of the two zones is moved away from the other.

According to an embodiment of the invention, the first and second elements are held against one another in the additional holding zone by deformation of a wall of the first element. As with the first holding zone, assembly is thus ensured without an additional part.

According to an embodiment of the invention, the first and second elements are held against one another by deformation of two walls of the first element, the two walls being located on either side of the second element.

Symmetrical holding is achieved, which ensures a better distribution of stresses.

According to another embodiment of the invention, the second element is held on the first element by tightening a fixing lug.

This allows a removable fitting to be achieved.

For example, the fixing lug is screwed into the first element. The structure of the first element is tapped, avoiding the use of a nut.

Alternatively, the fixing lug is fixed to the first element by a screw passing through the first element.

Another aim of the invention is an automatic gearbox incorporating a sensor as described above. The installation stresses are usually high for a gearbox-oil pressure sensor, numerous parts being located near the gearbox. The use of a sensor as described above is particularly advantageous for this application.

The invention also concerns a method of manufacturing a sensor as described above, comprising the following steps:

Position a first element of the sensor and a second element of the sensor against one another, the second element comprising a circular portion,

Hold the first and second element against one another other at a part of the circular portion of the second element, at a holding angle of less than 360 degrees, the holding angle being defined by the circular portion.

Preferably, the first and second element are held against one another at a part of the circular portion of the second element, at a holding angle of less than 360 degrees, by deformation of the first element. Deformation can thus be achieved for example by crimping or by rolling. Several deformations in different directions can be performed in order to increase the assembly's strength.

The invention will be better understood by referring to the accompanying figures, in which:

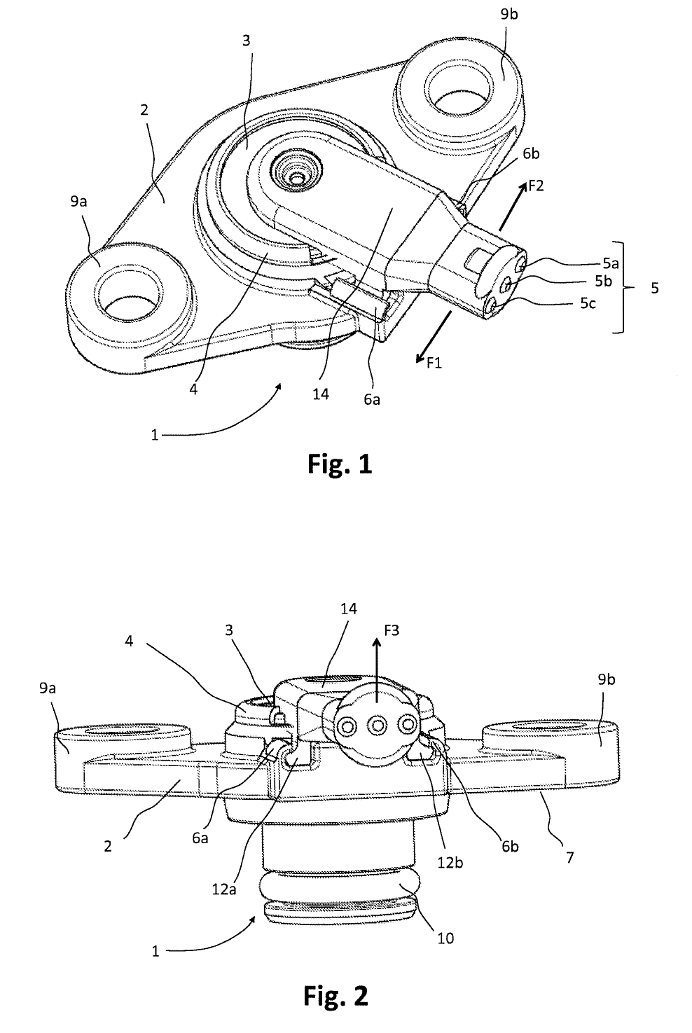

FIG. 1 is a perspective view of a sensor according to an embodiment of the invention, from a first viewing angle,

FIG. 2 is a perspective view of a sensor according to an embodiment of the invention, from a second viewing angle,

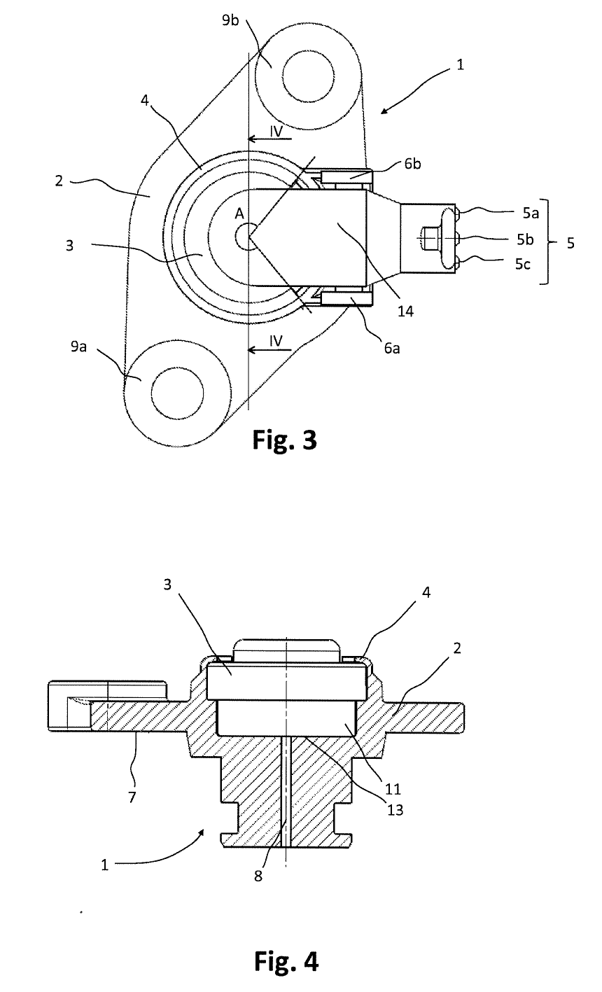

FIG. 3 is a top view of the sensor according to the invention,

FIG. 4 is a schematic partial cross-sectional view of a sensor according to an embodiment of the invention.

The sensor shown in FIG. 1 comprises a first element and a second element comprising a circular portion.

Within the scope of the invention, the first element is configured to hold the circular portion of the second element against the first element, at a holding angle A of less than 360 degrees. This means that the second element is not held around its entire circumference. The first element is formed by a body 2. The body 2 holds all of the elements of the sensor. According to an embodiment of the invention, the body is formed of at least one part. According to another embodiment of the invention, the body is formed of at least two parts, and for example a part of the body associated with a flange.

The second element is formed by a housing 3. The housing is associated with a sensor connector. More precisely, the housing 3 incorporates a connector 5 enabling the sensor to be connected to a measuring instrument. The housing 3 also closes and seals the sensor. According to an embodiment, the second element 3 is over-molded onto connection tabs, not shown. According to an embodiment, the second element 3 of the sensor 1 comprises, in the example shown in FIGS. 1 and 3, three connections 5a, 5b, 5c.

The holding angle A is defined by the circular portion. The angle A is defined in a direction perpendicular to the flat surface 13 of the first element, as shown in FIG. 3, where the viewing direction is perpendicular to the bearing surface 7.

The first element 2 has a first flat surface 7 that rests on a flat surface of a part on which the sensor is fitted. For example, the sensor is fitted to a gearbox casing. This casing comprises a flat surface on which rests the first flat surface 7 of the first element 2 of the sensor 1.

The first element 2 comprises a second flat surface 13 and the second element 3 comprises a circular portion resting on the flat surface 13 of the first element 2.

More precisely and as shown in FIGS. 1 to 3, the first element 2 comprises a holding wall 4 surrounding the circular portion of the second element 3, the first and second elements being held against one another by deformation of the holding wall 4.

According to an embodiment of the invention, the first element 2 and the second element 3 are held against one another by crimping or by rolling. The crimping or rolling is thus made on an angular portion of less than 360 degrees.

According to another embodiment, the wall is deformed by rolling.

In both cases, the wall 4 is deformed by applying a special tool that rests on the wall 4 and pushes it back onto the second element until fully home. Rolling involves rotating the tool around the wall 4 in order gradually to deform it. Crimping involves the tool simultaneously deforming the entire wall 4. The sensor is arranged in a tool suitable to ensure the stability of the sensor during the application of the force deforming the wall 4.

According to an embodiment of the invention, not shown, the first and second element are held against one another by means of a portion of thrust washer arranged on the circular portion of the second element and on which the holding wall rests when it is deformed. The portion of thrust washer is in the form of a portion of disc with a hole in the middle, the portion of disc having an angle in the center of less than 360 degrees. The portion of thrust washer is thus inserted between the first and second element around the entire crimping zone.

Several deformations of the holding wall 4 in different directions can be performed in order locally to increase the contact forces between the body 2 and the housing 3 and to increase the strength of the assembly.

According to an embodiment, not shown, notches are made in the holding wall 4. For example, the notches are V-shaped.

Alternatively, an additional deformation of the wall 4 is made by pressing a round-ended punch against the wall 4.

The hold being achieved on an angular portion of less than 360 degrees, and unlike the sensors of the prior art, it is possible to make a connector that exits in a direction parallel to the bearing surface 7. The distance between the top of the element 3 and the bearing surface 7 is thus minimized. The sensor is therefore more compact and consequently easier to fit into its environment.

The first element 2 is metallic. The metal of the wall 4 is deformed in its plastic zone, meaning that the deformation is permanent. Within the scope of the invention, the plastic zone means a zone that can be deformed in an irreversible manner. The assembly is final and the sensor cannot be removed.

According to an embodiment of the invention, the first element 2 is made of stainless steel. This type of material can be used for its mechanical resistance and its good anticorrosion properties.

According to a variation of the invention, the first element 2 is made of brass. This type of material is in particular used when the mechanical stresses are low.

According to another variation of the invention shown, the first element is made of aluminum.

More precisely, the first element is a part obtained by casting. This type of obtaining method is particularly suitable when the part comprises complex forms or has no rotational symmetry. In fact, making the body 2 by an aluminum casting method is cheaper than using a method based solely on machining.

Advantageously, the holding wall 4 is perpendicular to a flat surface of the second element held against the first element. During assembly of the sensor, the holding wall thus allows the second element to be guided when it is being positioned against the first element.

The second element comprises an elongated part 14 extending the second element beyond the circular portion. The elongated part 14 means a part exceeding the virtual circle formed by the extension of the circular portion of the second element. The elongated part is thus not specifically elongated but can have any form that allows it to exceed the unheld circular portion, in the same plane as the circular portion.

According to an embodiment of the invention, this elongated part supports the connector of the sensor.

The first element 2 comprises an orifice allowing a fixing screw to pass through in order to connect the sensor to a part keeping the sensor in contact with the fluid of which a property is to be measured. More precisely, the body 2 comprises 2 fixing lugs 9a, 9b through which a fixing screw passes, these screws not being shown.

In another embodiment, not shown, the first element 2 comprises a thread allowing the sensor 1 to be fitted onto a part keeping the sensor in contact with the fluid of which a property is to be measured.

According to an embodiment of the invention, the sensor 1 comprises a sensitive element enabling the pressure of a fluid to be measured. The sensitive element, not shown, is arranged in the cavity 11 located in the body 2. The fluid can, for example, be air or a gaseous mixture containing fuel.

According to the embodiment shown, the sensor 1 comprises a sensitive element allowing the pressure of a liquid to be measured.

According to an embodiment of the invention, the sensor 1 comprises a sensitive element allowing the temperature of a fluid to be measured; and, for example, oil, air or any other fluid of which the temperature can be measured.

More precisely, the first element 2 comprises a sensitive element allowing the pressure of the oil of an automatic gearbox for a motor vehicle to be measured. The oil can pass into the channel 8 to come into contact with the sensitive element. The measurement of the gearbox oil pressure allows the electronic system controlling the gearbox to optimize the gear change phases.

According to an embodiment of the invention, the sensor 1 comprises an additional zone to hold the second element 3 against the first element. This additional holding zone is configured to enable the rotation of the second element 3 in relation to the first element 2. Preferably, the additional holding zone is outside the circular portion of the second element 3.

The additional holding zone consists of two additional elements 6a and 6b.

The additional elements 6a and 6b play the role of a stop and oppose a rotational movement of the second element 3 in relation to the first element 2. This type of stress, symbolized in FIG. 1 by forces F1 and F2, can be applied on the sensor during the phase of fitting the sensor onto the vehicle, mainly when connecting the cable bundle. This type of stress can also be generated when removing the sensor, for example during an overhaul or repair of the vehicle. A stress of the type of forces F1 and F2 tends to make the body 2 and the second element 3 rotate in relation to one another. Such a rotational movement is to be avoided because this would damage the sensor, particularly its internal electrical connections. The second holding zone thus limits the stresses transmitted to the first holding zone and eliminates the risks of damage to the sensor.

As shown in FIGS. 1 and 2, the additional holding zone is configured so as to prevent the displacement of the second element in relation to the first element. Displacement means a stress exerted in a direction perpendicular to the flat surface 7 of the sensor 1, as illustrated in FIG. 2 by force F3. As zones 6a and 6b resist the stresses along F3, the stress transmitted to the first holding zone and in particular to the holding wall 4 is significantly reduced. As stated above, this type of stress can be applied during the phases of fitting the sensor onto the vehicle, as well as during the removal phases.

The distance separating the second holding zone from the center of the circular portion of the second element is between 1.1 and 2.5 times the radius of the circular portion of the second element. The greater this distance, the greater the anti-torque and anti-displacement effect. By distancing the second holding zone from the first, its efficiency is increased because for a given applied torque, the maximum stress will decrease if the 2 zones are spaced apart.

As shown in FIG. 1, the first and second elements are held against one another in the additional holding zone by deformation of at least one wall 6a of the first element. According to an embodiment of the invention shown in FIGS. 1 and 2, holding is ensured by two walls 6a, 6b. As with the first holding zone, assembly is ensured without an additional part.

More precisely, the 2 walls of the first element are folded over a part of the second element. The walls 6a and 6b are thus folded over the holding rims 12a, 12b made in the second element 3. The two walls 6a and 6b thus oppose the forces being exerting in the direction and path of F3. The forces in the opposite direction to F3 are absorbed by element 3 resting on the body 2, particularly at the holding rims 12a and 12b.

According to another variation of the invention, not shown, the second element is held on the first element by tightening a fixing lug.

The fixing lug can for example be screwed into the first element, a tapped hole being made in the structure of the first element.

According to another embodiment of the invention, the fixing lug is fixed to the first element by a screw passing through the first element. Depending on the stresses likely to be applied, particularly by the pressure of the fluid, the number of fixing points could be increased. The configuration in FIG. 3 allows for 2 fixing points at the fixing lugs 9a, 9b, enabling the forces to be distributed.

The application described also concerns an automatic gearbox incorporating a sensor as previously described. The sensor is fixed onto the gearbox by means of the fixing lugs 9a, 9b. The body 2 has a flat surface 7 that rests on a flat surface of the gearbox. A protrusion of the body 2 is inserted into a hole in the gearbox. A channel 8 is made in this protrusion and the channel 8 communicates with a part of the gearbox in which pressurized oil circulates. A sealing ring 10 is arranged in a groove in the protrusion in order to seal the gearbox.

The method of manufacturing a sensor according to the invention involves the following steps:
position a first element of the sensor and a second element of the sensor against one another, the second element comprising a circular portion;
hold the first and second element against one another at a part of the circular portion of the second element, at a holding angle of less than 360 degrees, the holding angle being defined by the circular portion.

Preferably, holding the first and second element against one another at a part of the circular portion of the second element, at a holding angle of less than 360 degrees, is ensured by a deformation of the first element.

The deformation of the wall 4 of the body 2 is achieved for example by crimping or by rolling. A tool is rested on the wall 4 in order to push back the material of the body 2 against the housing 3.

The scope of the present invention is not limited to the details given above and allows embodiments in numerous other specific forms without departing from the field of application of the invention. Consequently, the present embodiments must be regarded as being by way of illustration and can be changed without, however, departing from the scope defined by the claims.

1. A sensor comprising:
a first element; and
a second element comprising a circular portion,
the first element being configured to hold the circular portion of the second element against the first element, at a holding angle of less than 360 degrees.

2. The sensor according to claim 1, wherein the first element comprises a deformable holding wall surrounding the circular portion of the second element, to hold the first and second elements against one another.

3. The sensor according to claim 2, wherein holding is ensured by crimping or rolling.

4. The sensor according to claim 1, wherein the first element is made of aluminum.

5. The sensor according to claim 1, wherein the first element is a part obtained by casting.

6. The sensor according to claim 1, wherein the second element comprises an elongated part extending the second element beyond the circular portion.

7. The sensor according to claim 1, comprising an additional zone for holding the second element against the first element, at the elongated part.

8. The sensor according to claim 7, wherein the additional holding zone is configured so as to prevent the rotation and/or displacement of the second element in relation to the first element.

9. The sensor according to claim 7, wherein the first and second elements are held against one another in the additional holding zone by deformation of at least one wall of the first element.

10. The sensor according to claim 1, wherein the first element is a sensor body formed by at least one part.

11. The sensor according to claim 1, wherein the second element is a sensor housing associated with a sensor connector.

12. An automatic gearbox incorporating a sensor according to claim 1.

13. The sensor according to claim 1, wherein the sensor is used in a motor vehicle.
